(19) United States
(12) Patent Application Publication
(10) Pub. No.: US 2006/0020425 A1
(43) Pub. Date: Jan. 26, 2006

(54) Monitor production status query system

(76) Inventor: Eric Chang, Taipei Hsien (TW)

Correspondence Address: LEONG C LEI, PMB # 1008, 1867 YGNACIO VALLEY ROAD, WALNUT CREEK, CA, 94598, US

(21) Appl. No.: 10/894,041

(22) Filed: Jul. 20, 2004

(51) Int. Cl. G06F 11/00

(52) U.S. Cl. 702/188; 700/108

(57) ABSTRACT

A monitor production status query system comprising a query data input device, a production status data output method, and a production status query interface to contain production status data input and collection and conversion of data into charts and graphics that are easier readable to the user; charts and graphics generated also providing a query interface for further access to the production status for the manager to achieve optimal production line control.

### BACKGROUND OF THE INVENTION

(a) Technical Field of the Invention

The present invention is related to a monitor production status query system, and more particularly to one that comprises a production status query data input device, a production status query data output method, and a production status query user interface to link and process information available from the inputs from production, assembly and inspection into a central server to create graphics using a built-in graphic generator in the server for keeping the user updated with the monitor production status on the graphics generated and a user interface disposed on the graphics.

(b) Description of the Prior Art

The use of a monitor is becoming a must in modern life either in one's food, clothing, accommodation, transportation, entertainment, or jobbing environment; thus the production of the monitor on commercial scale is nothing less important.

Since the invention of production line by Henry Ford, production lines has been massively applied in various industries. Product compositions are divided into multiple segments, and each segment is even further subdivided into parts; those parts are then assembled into segments using manual and mechanical means; all segments are then assembled in sequence to come up with a finished product; finally the product is delivered to the customer before surviving the QC test and inspection. However, any act of omission or negligence by any operator on the production line, any error from any process machine, or any nonconformity parts will result in a defective product as judged by the QC to warrant disassembly, analysis, repair or rework, reassembly and retest to result in higher production cost. Judging from the manufacturing industry of monitor, sophisticate circuits, namely, connection device, signal conversion device, central processor, display control device, and power source device, electrochemistry, namely, Cathode Ray Tube (CRT), Liquid Crystal Display (LCD), and Plasma Display Panel (PDP), and precision parts and installation incorporated to the casing and support structure are involved. Therefore, the monitor manufacturing industry is practically giving no economic value saving the strict QC procedure over the entire manufacturing process.

In use, the monitor is usually connected to a computer. Therefore, the computer can be designed to inspect the circuits (connection device, signal conversion device, central processor, display control device and power source device) of the monitor, and the precision electrochemistry (CRT, LCD, PDP) of the monitor. Computer is generally used for QC inspection on the current production line of monitor. Inspection always generates results and numerical readings and they come in large and complicate scale since many items of inspection are required. It takes very experienced QC personnel to analyze and formalized those inspection results and numerical readings. How to achieve precision analysis and quality control from those forms is highly challenging.

Furthermore, production line controllers, QC personnel, plant manager, salespersons, sales manager, managing director, auditor of the company, and even the client all expect to have fast access to the information of the production progress to cope with the market changing by seconds. The common scene is that when a question about quantity of output, it is usually answered by the plant manager; QC issues, by QC personnel; and other issues, the production line controller. In such way, production control is totally nonsense and it becomes even more difficult for quality control. As a result, the company faces higher production cost and thus weakening competition strength.

### SUMMARY OF THE INVENTION

The primary purpose of the present invention is to provide a monitor production status query system that keeps the user updated with the monitor production status. To achieve the purpose, the present invention is comprised of a query data input device, a production status data output method, and a production status query interface to contain production status data input and collection and conversion of data into charts and graphics that are easier readable to the user. Those charts and graphics generated provide a query interface for further access to the production status for the production manager to achieve optimal production line control.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow chart showing a first half of a first preferred embodiment of the present invention.

FIG. 2 is a flow chart showing the entire system of the first preferred embodiment of the present invention.

FIG. 3 is a flow chart showing a second half of the system of the first preferred embodiment of the present invention.

FIG. 3.1 is a flow chart showing a second half of the system of another preferred embodiment of the present invention.

FIG. 4 is a view showing a first window of the production system query of the present invention.

FIG. 5 is a view showing a second window of the production system query of the present invention.

FIG. 6 is a view showing a third window of the production system query of the present invention.

FIG. 7 is a view showing a fourth window of the production system query of the present invention.

FIG. 8 is a table showing production system query results.

FIG. 9 is a table showing production system query results.

FIG. 10 is a table showing production system query results.

FIG. 11 is a table showing production system query results.

FIG. 12 is a table showing production system query results.

FIG. 13 is a table showing production system query results.

FIG. 14 is a table showing production system query results.

FIG. 15 is a table showing production system query results.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

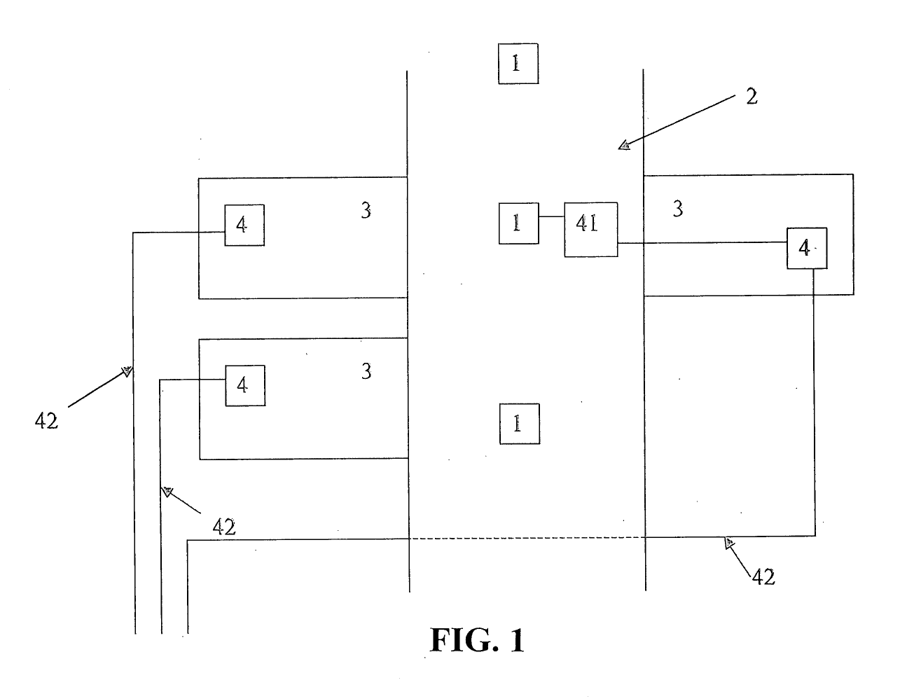

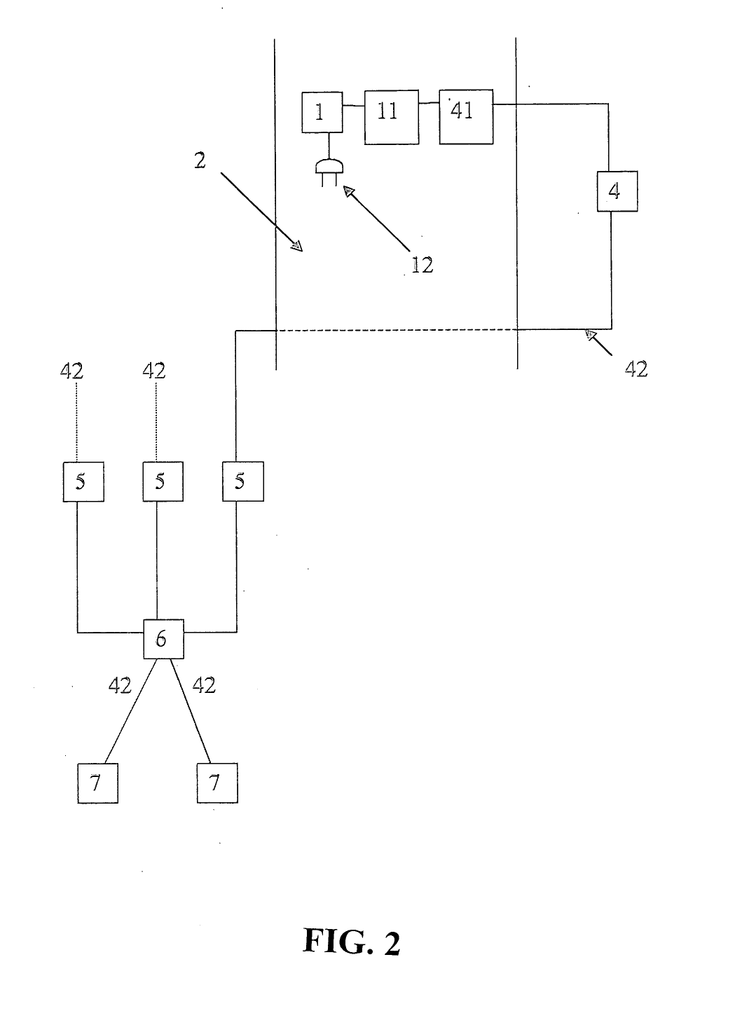

Referring to FIG. 1, a work piece of a monitor [Product (1)] pending process in a form of a CRT, LCD, or PDP is placed in a production line (2) comprised of a conveyer (which may be comprised of a desktop belt conveyer, a curved belt conveyer, a roller conveyer table, a curved roller conveyer table, a gravity chain conveyer, a gravity preheated production line, transfer carrier, or a suspension conveyer); multiple workstations (3) disposed by the production line (2) where a work piece of the monitor [Product (1)] is pending process to allow the stay of the work piece to be processed; a data collection temminal (4) adapted with an identification system being each provided at multiple workstations (3); a communication interface (41) connected to the work piece of the monitor [Product (1)] pending process, and operation being done either by manual or programs for the resultant numeric values to be outputted via a network (42). As illustrated in FIG. 2, when the communication interface (41) of the data collection terminal (4) adapted with the identification system is connected to an adapter (11) from the work piece of the monitor [Product (1)] and the work piece of the monitor [Product 1] is connected to a power source (12), the status of the work piece of the monitor [Product (1)] is inputted into a computer. Once the data collection terminal (4) adapted with the identification system collects the data, a data collection server (5) pools the information from all the data collection terminals (4) each adapted with the identification system on the production line, and transmits the information via the network (42) to provide the manager real time on-line information of the production line (2). Data from the data collection server (5) from the network (42) are transmitted to a central server (6). A query terminal (7) connected to the central server (6) via the network (42) retrieves the data completed with operation and stored in the central server (6) with the data transmission may be processed by encryption and decryption.

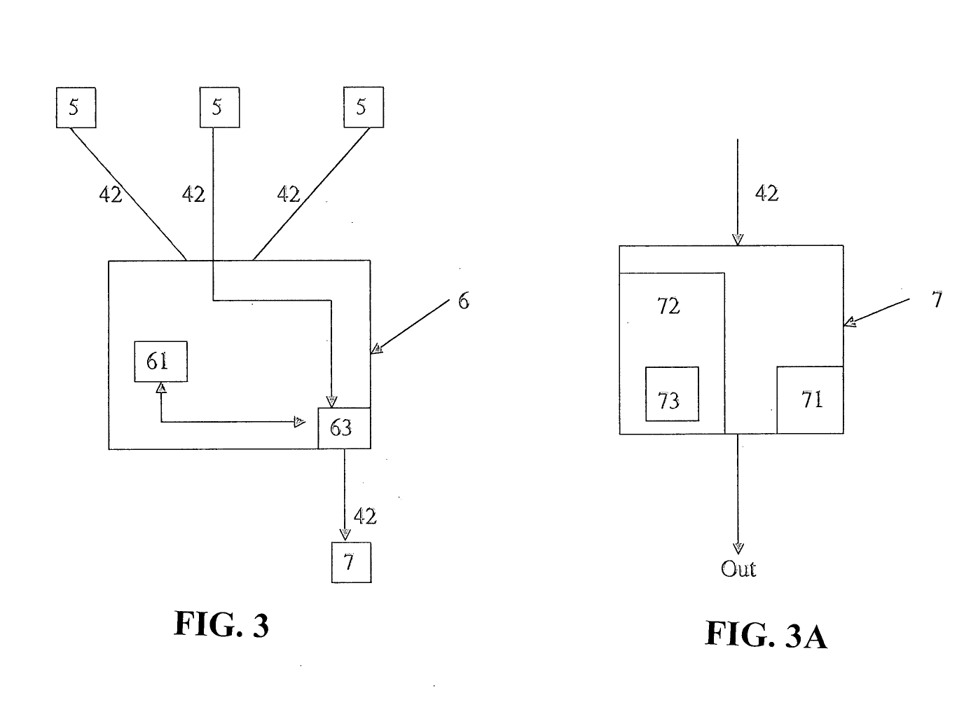

Referring to FIG. 3, when the data from the data collection server (5) are transmitted via the network (42) to the central server (6), the central server (6) is connected to a storage device (61). If a query on the production status of the monitor [Product 1] is made from the query terminal (7) via the network (42), a central process chip (63) in the central server (6) starts to operate those numeric values transmitted from the storage device (61) and those transmitted from the data collection server (5) and collected by the storage device (61), the graphics generated after the operation is delivered via the network (52) to the query terminal (7).

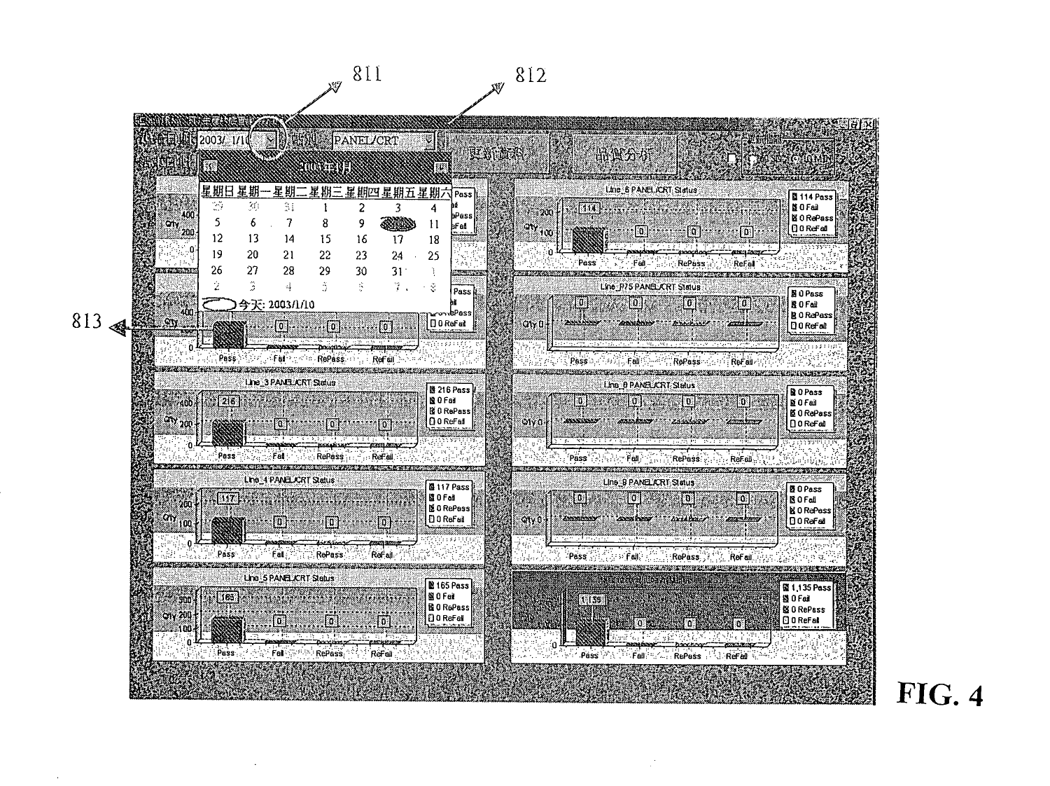

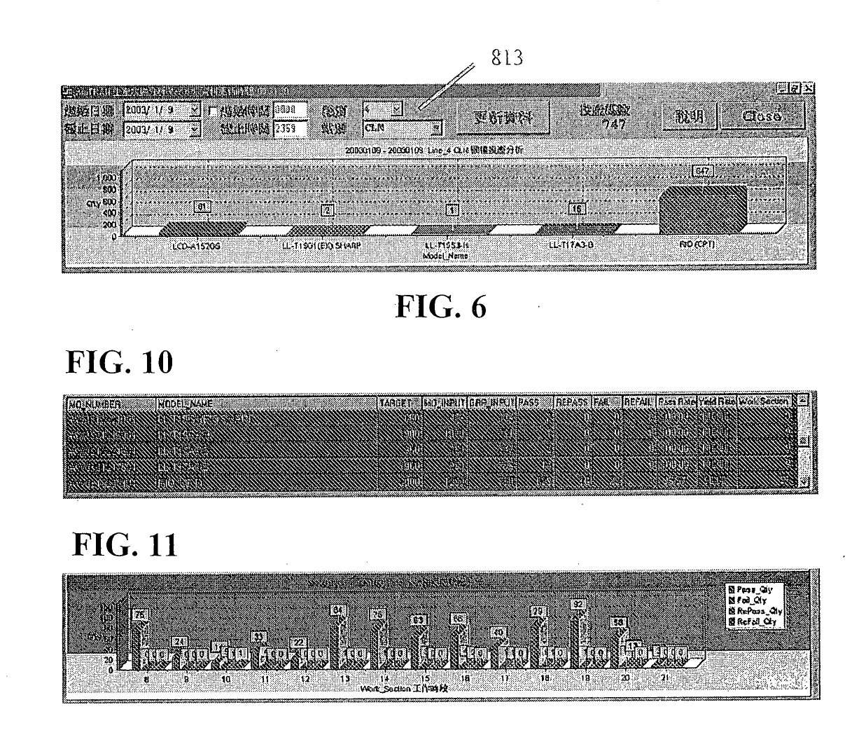

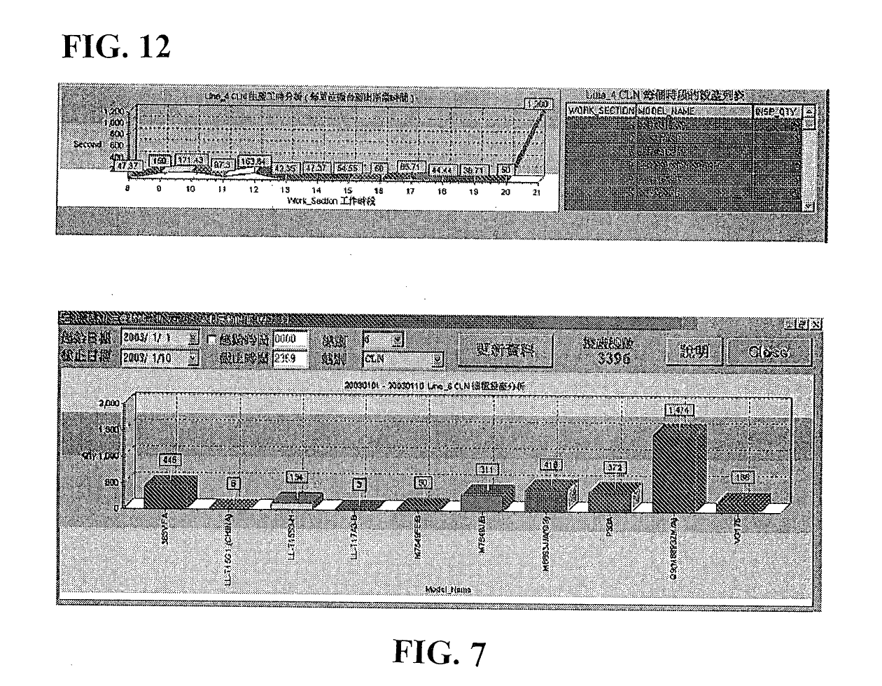

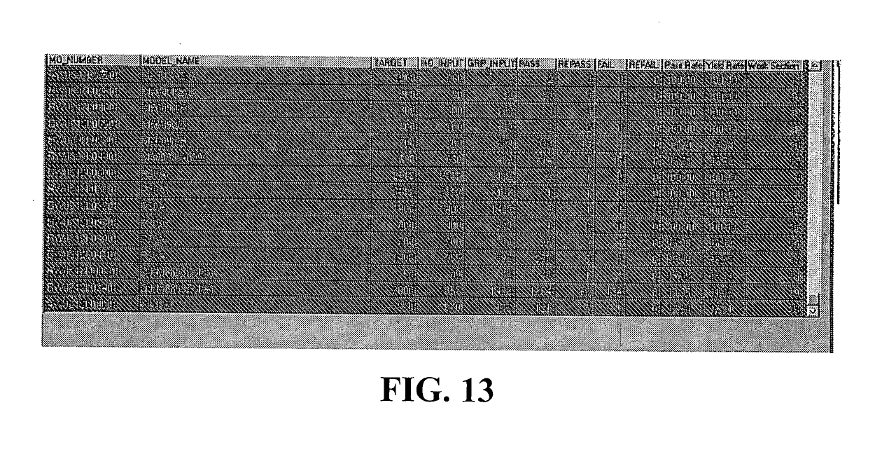

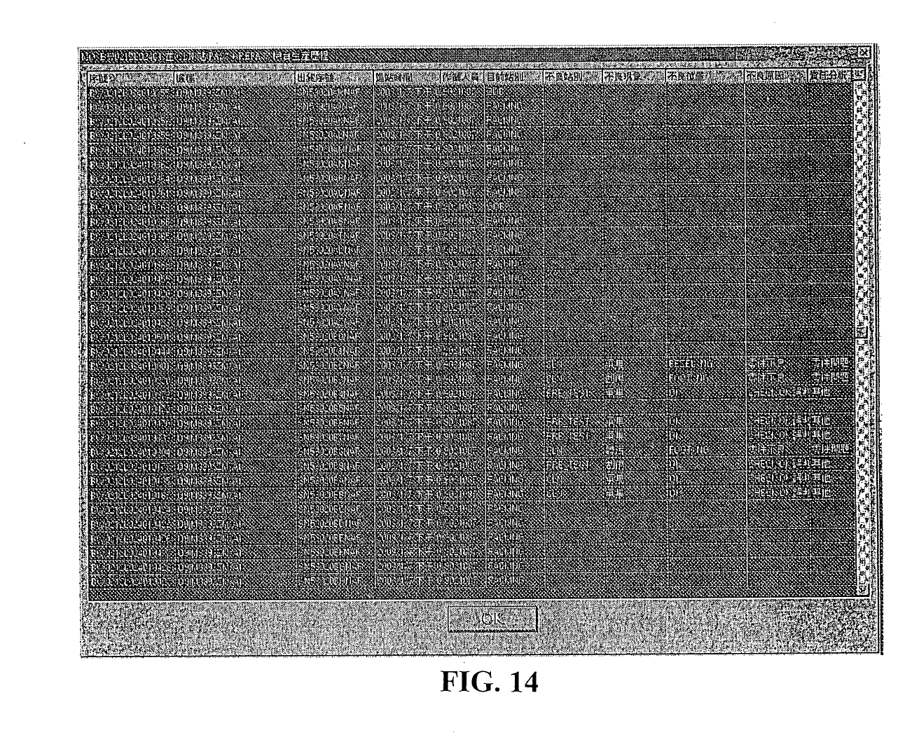

As illustrated in FIG. 3-1, the query terminal (7) relates to a personal computer provided with communication interface containing a central processor (61), and a storage device (72) comprised of a hard disk. The storage device (72) of the query terminal (7) contains a graphic generator (73) comprised of a program language with its syntax respectively comprised of ASP, JAVV and NET Once a query is made from the query terminal (7) through the network (42) for the production status of the monitor [Product (1)], the central processor chip (63) of the central server (6) starts to operate those numeric values transmitted from the data collection server (5) and collected by the central server (6), and then delivers the resultant operation to the query terminal (7) via the network (52). A graphic (8) generated after the operation contains a user interface to permit the user to execute the query of production status of the monitor [Product (1)]. As illustrated in FIG. 4, the user interface includes a time input (811) to provide the production status query at that production time and to output a graphic (813) of the quantity of output at the time of input as illustrated in FIG. 6. The time input contains columns of Start Date, Start Time, End Date and End Time. Under conditions of multiple-day query as illustrated in FIG. 7, the program will automatically magnify the column of the work order. Wherein, an X-Y bar chart shows the quantity of output and the type of the monitor, and a list of figures appears below the X-Y bar chart (FIG. 13). There are columns of work order number, product model, target, work order input, interval input, pass, second pass, service, second service, pass ratio, and output ratio. To make query of the quantity of output at a certain time as illustrated in FIG. 14, click on Column Pass on the work order to search for the production history, and type the duration of time of the query is desired in Columns Start Time and End Time on the screen.

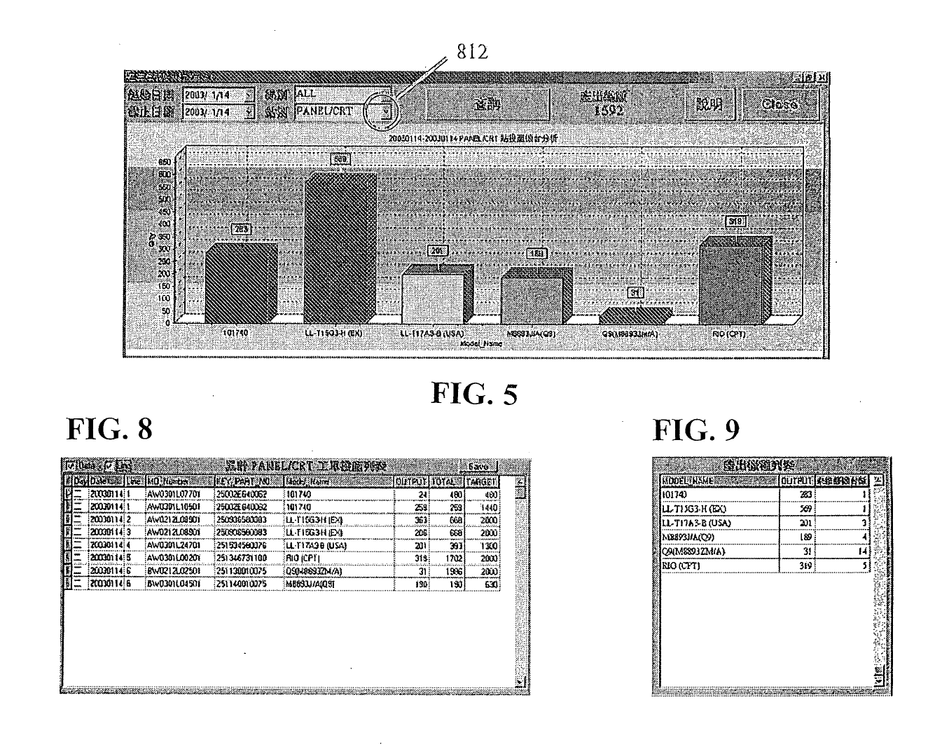

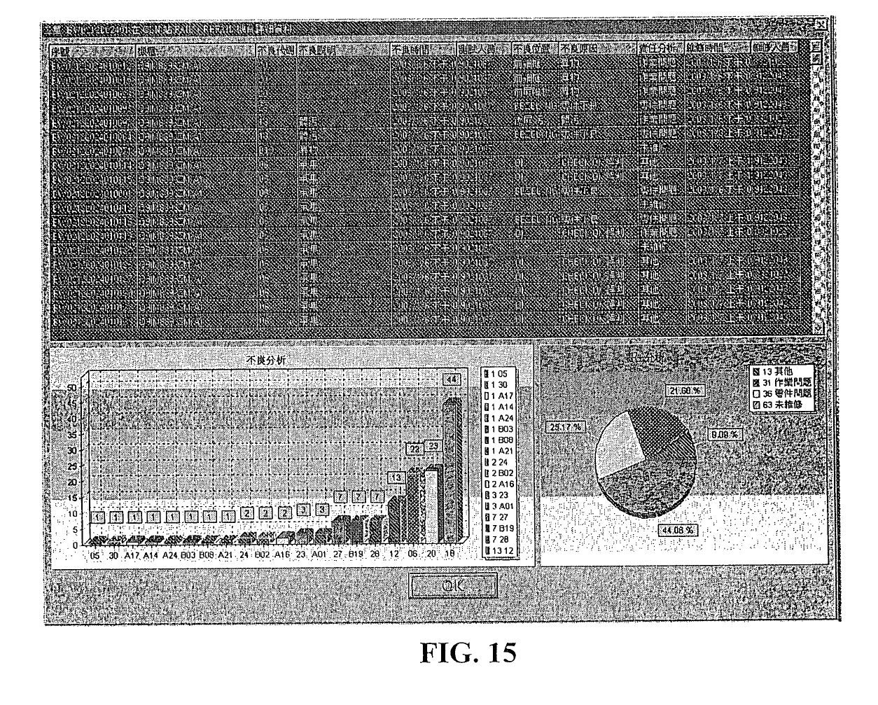

When Column Service in FIG. 15 is clicked followed by typing the duration of time of the query is desired in Columns Start Time and End Time on the screen, the query of defective and service results occurred at a certain time can be made and the query results are listed in numeric columns of series number, product type, NG code, NG description, NG time, test crew, NG address, NG cause, liabilities analysis, length of service time and service crew. A circular chart for the analysis of liabilities and a bar chart of nonconformity analysis appear below those numeric columns for fast analysis. A workstation selection input (712) permits the query of the production status at that workstation and the output of the generation of a chart of quantity of output of the production status at the workstation selected. As illustrated in FIG. 5, when “a11” is selected at the workstation selection input (712), product type, output quantity, and work order details of the entire plant on the selected date can be viewed at the angel of the entire plant, wherein, output quantity and product type are indicated on the X-Y bar chart. Below the X-Y bar chart, a list of accumulated work orders inputted (FIG. 8) and another list of product type outputted (FIG. 9) appear. The list of accumulated work orders inputted contains items of number of days, time, identification of production line, work order number, key-in originator ID, model number of the monitor, quantity of output, total quantity, and target while the list of product type outputted contains items of product model number, output quantity and number of units pending service.

Now referring to FIG. 6, by clicking the selection input, a product status quantity chart (813) appears to output detailed production data including work order (FIG. 10), detailed product type (FIG. 11) and output quantity per hour (FIG. 12) analysis.

The present invention provides many advantages including but not limited to:

1. Achieving the real-time control of production line: by having the computer at the workstation connected to the monitor pending process, the network reports real time status back to the server on the production line; accordingly, the production line manager is able to have non-transitional, and real time control of each monitor pending process to significantly improve the precision of production line control and meet upgraded quality requirements.

2. Control interface graphics: while being fully occupied by business to attend to each day, high ranking official from the management and the owner of the employed manufacturing both have to spare time on checking out the production status; accordingly, piles of reports and production statements on the desk not only increases work hours but also fails the total absorption of the information. As a result, such query is at its best consuming the work resources. Given with the present invention to provide data input methodology of query of monitor production status, graphics are generated for easy access to be updated with the production status. The presentation of query results in graphics also provides a much more efficient way of working, since the manager is using his/her right hemisphere of brains (to process the information received by graphic in a jiffy of time, thus the manager is able to fast process massive information) and usually when one's working, the use of the right hemisphere of brains is less likely when compared to the left hemisphere of brains. Graphics offers fast query and understanding of the resultant data instead of spending a lot of time on checking out the conventional reports and figures.

3. Real time control: whereas the present invention provides a query user interface for the monitor production status includes a time input, a workstation selection input and a quantity of output chart of production status, any problem identified on the manufacturing process can be real time solved to pay the production control its maximal benefits. This is particularly important for the production of monitor since sophisticate circuits, namely, connection device, signal conversion device, central processor, display control device, and power source device, electrochemistry, namely, Cathode Ray Tube (CRT), Liquid Crystal Display (LCD), and Plasma Display Panel (PDP), and precision parts and installation incorporated to the casing and support structure are involved in the manufacturing process. With the present invention, any information at each workstation is immediately accessible to the production manager and any problem can be immediately identified and solved to bypass the lengthy process as found with the prior art that any problem if identified must be reflected by the workstation to the shift leader of the production line, section chief, plant manager and the management of the company and the problem may be out of control at the time the management of the company is informed and tries to correct the problem. The query methodology disclosed by the present invention for permitting the workstation operator and the management of the Company to be informed of the same problem at the same time, thus to come up with the immediate action to correct the problem provides the optimal benefits to the manufacturer of the monitor.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A monitor production status query data input apparatus comprising:
a work piece pending process;
a production line in the form of a conveyer to carry the work piece;
multiple workstations disposed by the production line to hold the work piece for the operator to complete the process as assigned;
a data collection terminal adapted with an identification system provided at the workstation to connect a signal connection device to the work piece either by manual or by programs and to transmit using a communication interface numeric values detected;
a data collection server disposed to the production line deployed with workstation to collect information from each workstation using the communication interface, provide information of production status to the production line controller, and to output those numeric values via a network;
a central server to collect the information collected by each data collection server and transmitted via the network, execute the operation and storage; and
a query terminal linked to the central server via the communication interface to collect the data after the operation and stored in the central server.

2. The monitor production status query data input apparatus of claim 1; wherein, the work piece pending process is related to display medium including CRT, LCD or PDP.

3. The monitor production status query data input apparatus of claim 1; wherein, the conveyor is related to a desktop belt conveyer, a curved belt conveyer, a roller conveyer table, a curved roller conveyer table, a gravity chain conveyer, a gravity preheated production line, transfer carrier, or a suspension conveyer.

4. The monitor production status query data input apparatus of claim 1; wherein, the data transmission between the central server and the query terminal is executed by encryption and decryption.

5. A monitor production status query data output methodology to generate graphics of the data collected on the production status for fast identification of the data of query being feasible; wherein, the central server pooling computer information collected from each production server via the network, operation for the data being completed by a central process chip in the central server including the central server being provided with a storage device and operation capability; the central server transmitting the operation results back to the query terminal; and programs in the query terminal converting data received from the central server into graphics to present at the query terminal.

6. The monitor production status query data output methodology of claim 5; wherein, the query terminal relates to a personal computer provided with a communication interface, containing a storage device in the form of a hard disk; and a graphic generator being stored in the software of the hard disk; and the programs in the query end converting the data received into graphics to present at the query terminal.

7. The monitor production status query data output methodology of claim 5; wherein, the graphic generator is related to an application stored in the hard disk with its syntax respectively comprised of ASP, JAVA and NET.

8. The monitor production status query data output methodology of claim 5; wherein, the query terminal relates to a personal computer adapted with a communication interface, containing a chip allowing pre-recoded programs; the graphic generator being stored in the software in the chip allowing pre-recorded programs; and the programs in the query end converting the data received into graphics to present at the query terminal.

9. A monitor production status query user interface to the query terminal those graphics generated after the operation of numeric values transmitted from the computer at the workstation and collected by the central server and those numeric values of the graphic generator in the storage device in the central process chip of the central server when a query of production status is made from the query terminal including:
a time input, to provide the production status at that time of production of the query and to output a chart of output quantity of the production status inputted at that time;
a workstation selection input to select the workstation in the query of the production status at that workstation, and to a chart of output quantity of the production status inputted at that workstation; and
a production status quantity chart to provide input by clicking, output detailed production data including product type details, work hour analysis, efficiency analysis; standard work hours data being provided; and efficiency being analyzed by comparing between the standard work hours and the actual work hours.

10. The monitor production status query user interface of claim 9;
wherein, an option of ‘all’ is selected for the workstation selection input to review quantity of the type of monitor and the work order details of the entire plant on the date selected and viewed at the angle of the entire plant.

11. The monitor production status query user interface of claim 9;
wherein, the option of ‘all’ being selected for the workstation selection input to review quantity of the type of monitor and the work order details of the entire plant on the date selected and viewed at the angle of the entire plant; and an X-Y bar chart being produced to indicate output quantity and product type; a list of accumulated work orders and another list of production type appearing below the X-Y bar chart; the list of the accumulated work orders containing items of number of days, time, identification of production line, work order number, key-in originator ID, model number of the monitor, quantity of output, total quantity, and target;
and the list of product type outputted containing items of product model number, output quantity and number of monitor pending service.

12. The monitor production status query user interface of claim 9;
wherein, the time input containing columns of start date, start time, end date and end time; and the programs automatically magnifying the column of work order details in case of query of production status of multiple days.

13. The monitor production status query user interface of claim 12;
wherein, the time input containing columns of start date, start time, end date and end time; under conditions of multiple-day query, the program automatically magnifying the column of the work order;
an X-Y bar chart showing the quantity of output and the type of the monitor; a list of figures appearing below the X-Y bar chart; and
columns of work order number, product model, target, work order input, interval input, pass, second pass, service, second service, pass ratio, and output ratio being provided.

14. The monitor production status query user interface of claim 13;
wherein, the time input containing columns of start date, start time, end date and end time; under conditions of multiple-day query, the program automatically magnifying the column of the work order;
an X-Y bar chart showing the quantity of output and the type of the monitor; a list of figures appearing below the X-Y bar chart;
columns of work order number, product model, target, work order input, interval input, pass, second pass, service, second service, pass ratio, and output ratio being provided; in making query of the quantity of output at a certain time, Column Pass on the work order being clicked to search for the production history; and the duration of time of the query desired being typed in Columns Start Time and End Time on the screen.

15. The monitor production status query user interface of claim 13;
wherein, the time input containing columns of start date, start time, end date and end time; under conditions of multiple-day query, the program automatically magnifying the column of the work order;
an X-Y bar chart showing the quantity of output and the type of the monitor; a list of figures appearing below the X-Y bar chart; and the query results being listed in numeric columns of series number, product type, delivery series number, time of in workstation, operator, current workstation, NG station, NG description, NG location, NG cause, and liabilities analysis.

16. The monitor production status query user interface of claim 15;
wherein, the time input containing columns of start date, start time, end date and end time; under conditions of multiple-day query, the program automatically magnifying the column of the work order;
an X-Y bar chart showing the quantity of output and the type of the monitor; a list of figures appearing below the X-Y bar chart;
columns of work order number, product model, target, work order input, interval input, pass, second pass, service, second service, pass ratio, and output ratio being provided; the service column being clicked; start time and end time being typed to define the scope of time of the query; and NG description and server results during a certain length of time becoming available.

17. The monitor production status query user interface of claim 16;
wherein, the time input containing columns of start date, start time, end date and end time; under conditions of multiple-day query, the program automatically magnifying the column of the work order;
an X-Y bar chart showing the quantity of output and the type of the monitor; a list of figures appearing below the X-Y bar chart;
columns of work order number, product model, target, work order input, interval input, pass, second pass, service, second service, pass ratio, and output ratio being provided; the service column being clicked; start time and end time being typed to define the scope of time of the query; NG description and server results during a certain length of time becoming available; service results including numeric columns of series number, product type, NG code, NG description, NG time, test crew, NG address, NG cause, liabilities analysis, service time and service crew; and a NG analysis bar chart and a circular chart of liabilities analysis appearing below the numeric columns for fast analysis purpose.

18. The monitor production status query user interface of claim 9;
wherein, length of the query being made for more than one day; and
the programs automatically showing a map of multiple-day output quantity changes.

19. The monitor production status query user interface of claim 18;
wherein, length of the query being made for more than one day; the programs automatically showing a map of multiple-day output quantity changes; the map including an X-Y bar chart showing output quantity and product type; a numeric list showing work order below the X-Y bar chart and containing number of days, date, production line ID, work order number, input originator ID, model, output quantity, total quantity and target; on the other side of the list of the work order appearing a product type list containing model, output, number of unit pending service; and a daily input quantity analysis X-Y curve chart to display quantity and date.
